(19) United States
(12) Patent Application Publication
(10) Pub. No.: US 2016/0327895 A1
(43) Pub. Date: Nov. 10, 2016

(54) IMAGE FORMING APPARATUS

(71) Applicant: CANON KABUSHIKI KAISHA, Tokyo (JP)

(72) Inventors: Nobuhiro Kikuchi, Moriya-shi (JP); Yasuharu Chiyoda, Nagareyama-shi (JP); Masahiro Tsujibayashi, Nagareyama-shi (JP); Satoru Yamamoto, Noda-shi (JP); Katsuya Nakama, Nagareyama-shi (JP)

(21) Appl. No.: 15/136,256

(22) Filed: Apr. 22, 2016

(30) Foreign Application Priority Data
May 8, 2015 (JP) 2015-095640
Mar. 3, 2016 (JP) 2016-040917

(51) Int. Cl. G03G 15/00; G03G 15/20

(52) U.S. Cl. CPC G03G 15/5016; G03G 21/1685

(57) ABSTRACT

An image forming apparatus includes an image forming portion configured to form a toner image on a recording material to execute a job; a fixing portion configured to fix, on the recording material, the toner image formed by the image forming portion, the fixing portion being capable of being replaced with another fixing portion depending on a content of the job; and a selecting portion configured to cause an operator to select one of a plurality of modes when a plurality of jobs are successively reserved. The plurality of modes includes a first mode in which execution order is changed so as to decrease a number of times of replacement of the fixing portion and then the plurality of jobs are executed in the changed execution order and a second mode in which the plurality of jobs are executed in reserved order.

### FIELD OF THE INVENTION AND RELATED ART

The present invention relates to an image forming apparatus for forming a toner image on a recording material. As this image forming apparatus, it is possible to use a copying machine, a printer, a facsimile machine and a multi-function machine having functions of these machines.

In recent years, species of media (recording materials: hereinafter also referred to as sheets) usable in image forming apparatuses of an electrophotographic type diversify in accordance with various customer needs. In the case where the image is formed on a special recording material such as an envelope, compared with other recording materials, it is required that pressure of a fixing device (apparatus) is largely changed.

In order to satisfactory effect image formation on the media of such various species, an image forming apparatus in which an exclusive fixing device depending on the species of the recording material is prepared and the fixing device used is exchanged (replaced) in accordance with the recording material used has been proposed (Japanese Laid-Open Patent Application (JP-A) 2008-58365).

However, in such an image forming apparatus, there is a problem as described below. For example, the case where a fixing device A suitable for various recording materials such as high-quality paper and coated paper and a fixing device B substantially specialized for the envelope are prepared and a plurality of jobs different in species of the recording material are executed will be considered. Specifically, for example, the case where a first job is a job using the envelope, a next job is a job using the high-quality paper and a final job is a job using the envelope will be assumed.

These 3 jobs are executed in such an order that first image formation on the envelope is effected using the fixing device B and then the fixing device B is exchanged to the fixing device A and image formation on the high-quality paper is effected and finally the fixing device A is exchanged to the fixing device B and image formation on the envelope is effected.

In this case, two times of the exchange of the fixing device are needed and therefore time and trouble of a user increase. Accordingly, when such 3 jobs are executed, there is a demand of the user such that the user wants to decrease the number of times of exchange of the fixing device. On the other hand, there is also a demand of the user such that the user wants to successively execute the jobs along a reserved order of the 3 jobs. It is required to meet such a variety of demands of the user.

### SUMMARY OF THE INVENTION

According to an aspect of the present invention, there is provided an image forming apparatus comprising: an image forming portion configured to form a toner image on a recording material to execute a job; a fixing portion configured to fix, on the recording material, the toner image formed by the image forming portion, the fixing portion being capable of being replaced with another fixing portion depending on a content of the job; and a selecting portion configured to cause an operator to select one of a plurality of modes when a plurality of jobs are successively reserved, the plurality of modes including a first mode in which execution order is changed so as to decrease a number of times of replacement of the fixing portion and then the plurality of jobs are executed in the changed execution order and a second mode in which the plurality of jobs are executed in reserved order.

According to another aspect of the present invention, there is provided an image forming apparatus comprising: an image forming portion configured to form a toner image on a recording material to execute a job; a fixing portion configured to fix, on the recording material, the toner image formed by the image forming portion; a mounting portion configured to selectively mount one of a plurality of fixing portions of species including a first fixing portion capable of fixing the toner image on the recording material of a predetermined species including a predetermined envelope and a second fixing portion capable of fixing the toner image on the recording material of a predetermined species not including the predetermined envelope; and a selecting portion configured to cause an operator to select one of a plurality of modes when a first job using a first fixing portion, a second job using a second fixing portion and a third job using a first fixing portion are successively reserved, the plurality of modes including a first mode in which the first job, the third job and the second job are executed in listed order and a second mode in which the first job, the second job and the third job are executed in listed order.

According to another aspect of the present invention, there is provided an image forming apparatus comprising: an image forming portion configured to form a toner image on a recording material to execute a job; a fixing portion configured to fix, on the recording material, the toner image formed by the image forming portion; a mounting portion configured to selectively mount one of a plurality of fixing portions of species including a first fixing portion capable of fixing the toner image on the recording material of a predetermined species including a first recording material and a second fixing portion capable of fixing the toner image on the recording material of a predetermined species not including the first recording material; a determining portion configured to detect a number of times of replacement of the fixing portions in a process in which a plurality of jobs are executed; and a selecting portion configured to cause an operator to select one of a plurality of modes when the plurality of jobs in which a plurality of numbers of times of replacement of the fixing portions is needed on the basis of a determination result of the determining portion are successively reserved, the plurality of modes including a first mode in which execution order is changed so as to decrease a number of times of replacement of the fixing portions and then the plurality of jobs are executed in the changed execution order and a second mode in which the plurality of jobs are executed in reserved order.

According to further aspect of the present invention, there is provided an image forming apparatus comprising: an image forming portion configured to form a toner image on a recording material to execute a job; a fixing portion configured to fix, on the recording material, the toner image formed by the image forming portion, the fixing portion being capable of being replaced with another fixing portion depending on a content of the job; and an executing portion configured to execute one of a plurality of modes when a plurality of jobs are successively reserved, the plurality of modes including a first mode in which execution order is changed so as to decrease a number of times of replacement of the fixing portion and then the plurality of jobs are executed in the changed execution order and a second mode in which the plurality of jobs are executed in reserved order.

Further features of the present invention will become apparent from the following description of exemplary embodiments with reference to the attached drawings.

### BRIEF DESCRIPTION OF THE DRAWINGS

FIG. 1 is an illustration showing an example of a selected screen displayed at a display portion of an operating portion.

FIG. 2 is an illustration showing an example of a selected screen displayed at a display portion of a PC.

FIG. 3A is a part of a flowchart showing an operation of an image forming apparatus, and FIG. 3B is a remaining part of the flowchart showing the operation of the image forming apparatus.

In FIG. 4, (a) and (b) are illustrations each showing an execution order of an image forming job.

FIG. 5 is a schematic structural view of an example of the image forming apparatus.

FIG. 6 is a rough block diagram of a control system.

FIG. 7 is a schematic structural view of a fixing device.

### DESCRIPTION OF THE EMBODIMENTS

The present invention will be described specifically based on Embodiments with reference to the drawings. Incidentally, the following embodiments are an example of a preferred embodiment of the present invention, but the present invention is not limited only thereto.

### Embodiment

### (1) Image Forming Apparatus

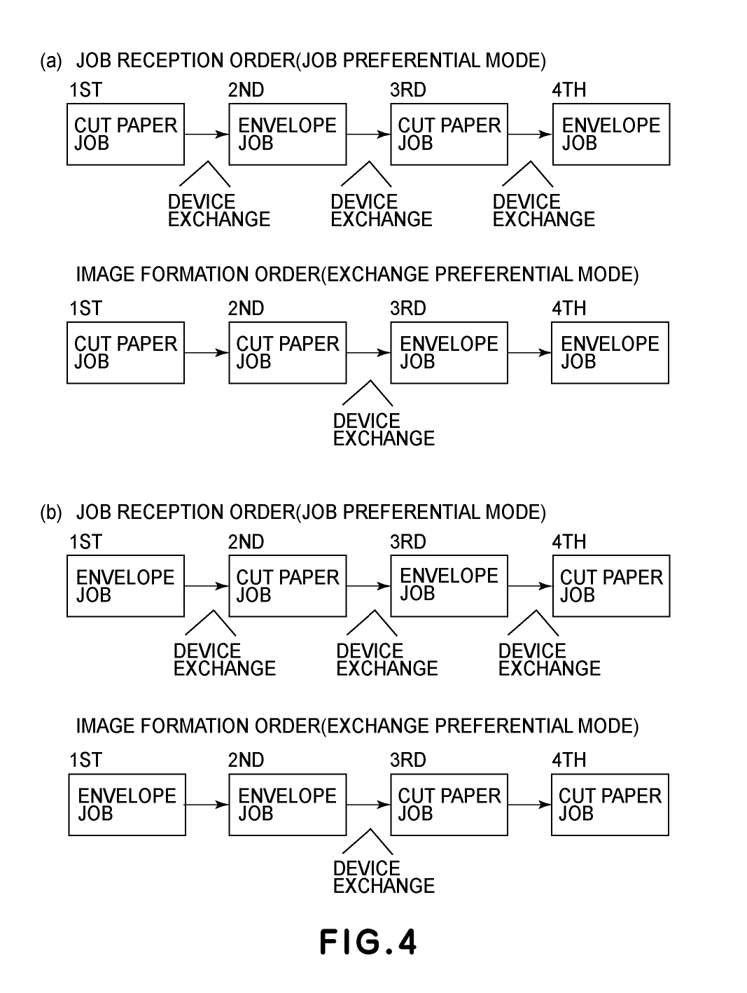

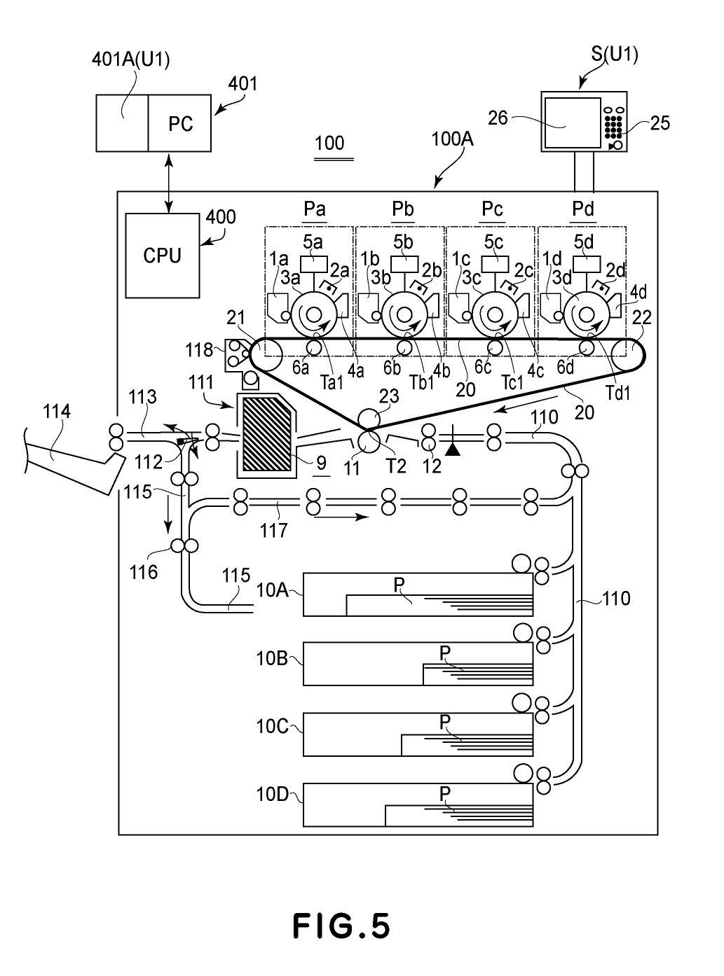

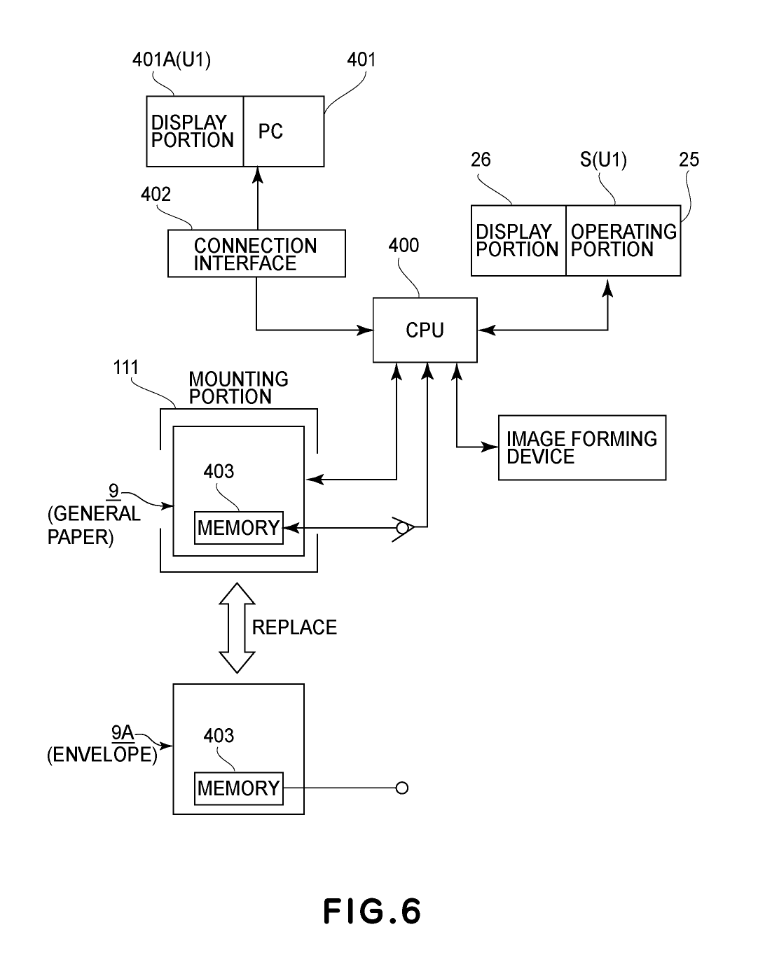

FIG. 5 is a schematic structural view of an image forming apparatus 100 in this embodiment, and FIG. 6 is a rough block diagram of a control system. This image forming apparatus 100 is an electrophotographic laser beam printer capable of forming a full-color image or a monochromatic image on a recording material P. That is, a job in which image data and recording material information inputted from a PC (personal computer) 401 connected with a CPU (controller) 400 via an operating portion (UI (user interface)) S or a connection interface 402 are added is inputted. An image forming operation corresponding to the inputted job is performed, so that an image-formed product is printed and outputted.

The recording material P is a sheet-like recording material (medium) on which a toner image is capable of being formed. Examples of the recording material P may include regular-sized or irregular-sized papers such as plain paper, thin paper, thick paper, high-quality paper, coated paper, an envelope, a postcard, a seal, a resin sheet, an OHP sheet, printing paper, format paper, and so on. Hereinafter, the recording material is referred to as a sheet. For convenience, treatment of the recording material (sheet) P will be described using terms, relating to the paper (sheet), such as sheet passing, sheet feeding, sheet discharge, a sheet-passing portion and non-sheet-passing portion, but the recording material is not limited to the paper.

The job (image forming job) refers to an image forming instruction in which printing condition information such as image data, species of designated sheet P, a basis weight, a sheet size, the number of sheets, the number of copies, a layout and a post-process is added.

In an apparatus main assembly 100A of the image forming apparatus 100, 5 image forming portions Pa, Pb, Pc, Pd for forming toner images of 4 colors consisting of yellow (Y), magenta (M), cyan (C) which are three primary colors for subtractive color mixture, and black (K) are provided. Further, the image forming apparatus 100 includes an endless intermediary transfer belt (intermediary transfer member, hereinafter referred to as a belt) 20. The belt 20 is extended and stretched around rollers 21, 22, 23 and is rotationally driven in the clockwise direction indicated by an arrow.

The image forming portions Pa, Pb, Pc, Pd include drum-shaped electrophotographic photosensitive members (hereinafter referred to as drums) 3a, 3b, 3c, 3d as image bearing members which are rotationally driven in the counterclockwise direction indicated by arrows and include image forming process means actable on the drums. In this embodiment, the image forming process means are charges 2a, 2b, 2c, 2d, laser scanners 5a, 5b, 5c, 5d, developing devices 1a, 1b, 1c, 1d, primary transfer chargers 6a, 6b, 6c, 6d and drum cleaners 4a, 4b, 4c, 4d.

A Y (yellow) toner image, an M (magenta) toner image, a C (cyan) toner image and a K (black) toner image formed on the drums 3a, 3b, 3c, 3d are successively primary-transferred superposedly onto the belt 20 at primary transfer nips Ta1, Tb1, Tc1, Td1, respectively. Incidentally, an image forming process and operation at each of the image forming portions are well known and therefore detailed description thereof will be omitted. A secondary transfer roller 11 is press-contacted to the belt 20 toward the roller 23 and forms a secondary transfer nip T2 between itself and the belt 20.

On the other hand, of sheet feeding cassettes 10A, 10B, 10C, 10D which are provided in multiple stages, a sheet feeding mechanism for the sheet feeding cassette in which the sheets P used in the job to be executed are accommodated is driven. As a result, one of the sheets P is separated and fed to pass through a sheet path 110, and thus is fed to a registration roller pair 12. The registration roller pair 12 feeds the sheet P to the secondary transfer nip T2 at predetermined control timing. As a result, the superposed toner images of the 4 colors of Y, M, C, K are collectively secondary-transferred from the belt 20 onto the sheet P.

The sheet P passed through the secondary transfer nip T2 is separated from the belt 20 and is introduced into a fixing apparatus (hereinafter referred to as a fixing device) 9. A surface of the belt 20 after separation of the sheet P is cleaned by a belt cleaner 118 and is repetitively subjected to image formation.

In this embodiment, the image forming portions Pa, Pb, Pc, Pd, the belt 20, the secondary transfer roller 12 and the sheet feeding mechanism constitute an image forming device for forming the toner images on the sheet (recording material) P.

The sheet P introduced into the fixing device 9 is subjected to heat-pressure fixing. The sheet P coming out of the fixing device 9 is induced toward a sheet discharging path 113 side by a flapper 112 and is discharged as a full-color image-formed product for one-side printing onto a sheet discharge tray 114 in the case of a one-side printing mode.

In the case of a double-side printing mode, the sheet P which come out of the fixing device 9 and which has already been subjected to printing on a first surface is induced toward a reverse path 115 by the flapper 112 and is pulled and fed into the reverse path 115 by normal rotation of a reversing roller 116. Then, the sheet P pulled in the reverse path 115 in a predetermined manner is introduced into a path 117 for double-side printing by reverse rotation of the reversing roller 116, and then is introduced again into the secondary transfer nip T2 via the sheet path 110 in a state in which the sheet P is turned upside down. As a result, the formation of the toner image on a second surface of the sheet P is made.

Subsequently, similarly as in the case of the one-side printing mode, the sheet P is fed through the fixing device 9 and the sheet discharging path 113 and then is discharged as a double-side image-formed product onto the sheet discharge tray 114.

In the case of monochromatic (single-color) image formation, the image forming portion necessary to effect the image formation performs an image forming operation, and at the image forming portions other than the image forming portion, associated drums are only idled and the image forming operation is not performed.

An operating portion S not only provides an image formation start instruction but also can make image quality setting of the image and input of information on the sheets P set in the sheet feeding cassettes 10A-10D using operation keys 25 and a display portion 26.

The display portion 26 is a liquid crystal screen of a touch panel type, and by the CPU 400, display of various pieces of information (display of messages), such as a state of the image forming apparatus, error information, jam information, another information and the like information can be made. Further, at the display portion 26, display of various operation buttons (keys) is also made. The user can make designation of printing condition (various settings) by also the operation buttons (keys) displayed at the display portion. The CPU 400 determines an image forming condition on the basis of the inputted information and effects image formation during image formation under a predetermined condition.

### (2) Fixing Device

The fixing device (apparatus) 9 is replaceable with another fixing device at a predetermined mounting portion 111 in a predetermined procedure and a predetermined manner. That is, the image forming apparatus 100 is capable of effecting image formation in a state in which the fixing device 9 mounted is replaced with another fixing device 9A customized to a particular recording material. Each of the fixing devices 9, 9A operates by transmission of a driving force and electric power supply from the apparatus main assembly 100A side in a state in which the fixing device is mounted to the mounting portion 111 of the apparatus main assembly 100A in a predetermined manner. Further, the fixing device transfers various pieces of control information with the CPU 400. A driving mechanism, an electric power supplying mechanism, a communication mechanism and the like for that purpose were omitted from illustration in the figures.

The fixing device 9 is a general-purpose fixing device capable of fixing images on general recording materials, except for an envelope, for example, recording materials of a variety of species such as thin paper, plain paper, thick paper, coated paper and high-quality paper. Further, the fixing device 9A is an exclusive (dedicated) fixing device customized exclusively to the envelope. Incidentally, the plain paper is exceptionally usable for the fixing device 9A. In the following, in this embodiment, the fixing devices 9, 9A described above will be described specifically, but the following constitution may also be employed.

For example, as the exclusive fixing device 9A, an exclusive fixing device customized to a special (particular) recording material other than the envelope.

Further, a constitution in which a structure itself of the fixing device but a size of a usable recording material is limited may also be employed. That is, a constitution in which the fixing device 9 is a fixing device for an A4-sized sheet (i.e., use of a recording material of less than the A4 size is prohibited), and the fixing device 9A is a fixing device for an A5-sized sheet (i.e., use of a recording material of less than the A5 size is prohibited) may also be employed.

This is because for example in the case where the A4-sized sheets are successively passed through the fixing device, such a problem that a fixing member is damaged by contact with side edges of the sheets and uneven glossiness generates on the image after fixing due to the damage is suppressed (solved). For that reason, for example, in the fixing device for the A4-sized sheet, passing of sheets of less than the A4 size is prohibited in principle. Accordingly, replacement of the fixing device is required.

In this way, as the reason why the fixing device is replaced, there can be not only the species of the recording material but also a width size of the recording material.

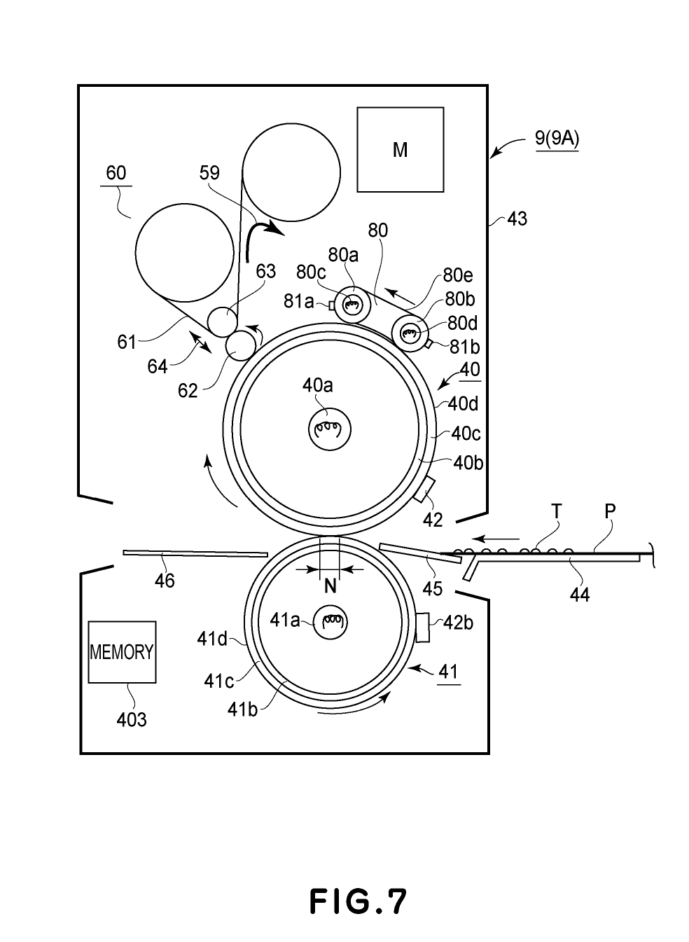

FIG. 7 is a structural illustration used in this embodiment. This fixing device 9 (9A) is an image heating apparatus of a heat roller type. An unfixed toner image T secondary-transferred on the sheet P is nipped and fed by a heating nip (fixing nip) N formed by press-contact between a fixing roller (heat fixing member) 40 contacted to an image surface and a pressing roller (pressing heat) 41 and is fixed on the sheet P. On an entrance side of the heating nip N, sheet guiding members 44, 45 are provided, and on an exit side of the heating nip N, a sheet guiding member 46 is provided.

That is, in this embodiment, the fixing device 9 (9A) includes a pair of rotatable members 40, 41 for fixing the toner image, formed on the sheet (recording material) by heat and pressure.

The fixing device 9 is used as a general paper fixing device, and the pressing roller 41 is press-contacted to the fixing roller 40 at a total pressure of 784 N (about 80 kgf), so that the heating nip N is formed.

The fixing roller 40 is constituted so as to have a diameter of 80 mm by forming a 3 mm-thick elastic layer 40c on an outer peripheral surface of the core metal 40b which is an aluminum-mode cylinder. The elastic layer 40c is an HTV (high-temperature vulcanising) silicone rubber layer. An outer peripheral surface of the rubber (elastic) layer is coated with a tube, as a parting layer 40d to be contacted to the image surface, principally formed of a copolymer of tetrafluoroethylene and perfluoroalkoxyethylene (hereinafter referred to as PFA).

The pressing roller 41 is constituted so as to have a diameter of 60 mm by forming a 1 mm-thick elastic layer 41c on an outer peripheral surface of the core metal 41b which is an aluminum-mode cylinder. The elastic layer 40c is, similarly as in the fixing roller 40, an HTV silicone rubber layer. An outer peripheral surface of the rubber (elastic) layer is coated with a PFA tube as a parting layer 41d. An outer diameter shape of the pressing roller 41 is a reverse crown shape such that an outer diameter at end portions is larger than an outer diameter at a central portion with respect to a longitudinal direction by 40 μm.

At rotation centers of the fixing roller 40 and the pressing roller 41, halogen heaters 40a and 41a for heating the rollers 40 and 41, respectively, are provided non-rotationally. In this embodiment, as the halogen heater 40a, a heater of 200 W in normal rated power was used, and as the halogen heater 41a, a heater of 400 W in normal rated power was used. The halogen heaters 40a and 41a are ON/OFF-controlled by the CPU 400 so that surface temperatures of the respective rollers are predetermined temperatures on the basis of output results of temperature detecting elements 42a and 42b, respectively, for detecting the surface temperatures of the rollers 40a and 41a, respectively.

Further, each of the fixing roller 40 and the pressing roller 41 is supported at both ends thereof by a fixing device casing 43 via a ball bearing and is rotatable. Gears (not shown) fixed to one ends of the fixing roller 40 and the pressing roller 41 are connected with each other by a gear mechanism, so that these rollers are rotationally driven integrally with each other in arrow directions by a driving force of a driving system (not shown) on the apparatus main assembly 100A side.

As a cleaning mechanism 60 for the fixing roller 40, a collecting roller 62 of 20 mm in diameter is provided so as to rotate in contact with the surface of the fixing roller 40, and in the case where the toner remains on the surface of the fixing roller 40 during fixing, the toner is collected by the collecting roller 62.

The collecting roller 62 is a hollow roller of aluminum and is coated as a surface layer with tetrahedral amorphous carbon. This is because a parting property with the PFA tube 40d as the surface layer of the fixing roller and ease of removal of the toner from the collecting roller 62 by cleaning are taken into consideration. That is, when the toner is collected from the fixing roller 40, the collecting roller 62 not only has a parting property lower than that of the PFA tube 40d as the surface layer of the fixing roller 40 but also is easily cleaned by a cleaning web 61 described later be removing the toner.

Further, the cleaning web 61 and a web roller 63 for supporting the cleaning web 61 and for urging the cleaning web 61 toward the collecting roller 62 are movable in an arrow 64 direction by a mounting and demounting mechanism M operated and controlled by the CPU 400. That is, the mounting and demounting mechanism M is operated by an instruction from the CPU 400 to effect mounting and demounting, and in a mounted state, the cleaning web 61 is urged against the collecting roller 62 with a force of about 40 N, so that the toner which is collected from the fixing roller 40 and which remains on the collecting roller 62 is removed by the cleaning web 61. The cleaning web 61 contacting the collecting roller 62 is wound up and fed in an arrow 59 direction, so that the surface thereof contacting the collecting roller 62 is always supplied (renewed) as a fresh surface where no toner is deposited.

The collecting roller 62 is supported by a ball bearing supported movably in a direction toward the fixing roller 40 and is rotatable. The collecting roller 62 is always contacted to the fixing roller 40, and in a non-contact state of the cleaning web 6, the collecting roller 62 is urged against the fixing roller 40 with an urging force of about 10 N by its own weight, so that a driving force is transmitted from the fixing roller 40 to the collecting roller 62 and thus the collecting roller 62 is rotated by rotation of the fixing roller 40. In a contact state of the cleaning web 61, the collecting roller 62 is urged against the fixing roller 40 with a force of about 50 N obtained by adding an urging force of 40 N to the above urging force of about 10 N, so that the driving force is transmitted from the fixing roller 40 to the collecting roller 62 and thus the collecting roller is rotated by rotation of the fixing roller 40.

An external heating device 80 is constituted by two external heating and supporting rollers 80a, 80b and an external heating belt 80e. The external heating device 80 is used for replenishing a heat quantity corresponding to an insufficient amount of supply by a heater 40a inside the fixing roller 40 and a heater 41a inside the pressing roller 41 relative to heat taken from the heating nip N by the sheet P, and has the function of maintaining a surface temperature of the fixing roller 40 at a predetermined temperature or more. The external heating belt 80e is provided for forming a broad nip with the fixing roller 40 thereby to increase a heat transfer amount.

Further, the external heating device 80 is detachably mountable mounting and demounting mechanism (not shown), and the CPU 400 controls the mounting and demounting mechanism, so that the external heating device 80 can be arbitrarily mounted to and demounted from the fixing roller 40. The driving force is transmitted from the fixing roller 40 to the external heating device 80 only when the external heating and supporting rollers 80a, 80b and the external heating belt 80e are urged in a state in which the external heating belt 80e is contacted to the fixing roller 40, so that the external heating belt 80e is rotated in an arrow direction.

The external heating and supporting rollers 80a, 80b are supported at both ends thereof by ball bearings and are rotatable, and at rotation centers thereof, halogen heaters 80c, 80d for heating the rollers 80a, 80b, respectively, are provided non-rotationally. In this embodiment, as the halogen heaters 80c, 80d, a heater of 1500 W in normal rated power was used.

When the external heating belt 80e is at rest, the halogen heaters 80c, 80d are ON/OFF-controlled by the CPU 400 so that a surface temperature of the belt 80e is a predetermined temperature on the basis of output results of temperature detecting elements 81a, 81b, respectively.

When the external heating device 80 is in a contact state with the fixing roller 40 and the external heating belt 80e starts rotation by the driving force from the fixing roller 40, the CPU 400 effects the following control. That is, the CPU 400 effects ON/OFF control of the halogen heaters 80c, 80d depending on an output value of only the temperature detecting element 81a positioned upstream of a nip formed by the external heating belt 80 and the fixing roller 40 with respect to the rotational direction of the external heating belt 80. However, the CPU 400 always continuously monitors also an output of the temperature detecting element 81b.

In the fixing device 9, a memory (nonvolatile memory) 403 as a discriminating portion indicating information (discrimination information corresponding to the species of the recording material for the fixing device customized to a particular recording material) on the type (species) of the fixing device is mounted. The information on the type of the fixing device is information for discriminating whether the fixing device is the general-purpose fixing device using a normal sheet or the exclusive fixing device customized to the envelope or special paper.

In the memory 403, the information on the fixing device type (species) is stored in advance, and the CPU 400 (controller) reads the information in the memory 403 of the mounted fixing device as desired. The CPU 400 includes an acquiring portion (acquisition function portion) for acquiring the discrimination information indicated by the discriminating portion 403 of the fixing device mounted in the image forming apparatus.

Incidentally, the discriminating portion 403 provided in the fixing device 9 is not limited to the memory. The discriminating portion 403 may only be required that the information can be acquired by the acquiring portion, and may also be mechanically constituted by a micro-switch or a dip switch. Specifically, for example, a constitution such that discrimination is made depending on whether or not how many electrical contacts of 10 electrical contacts are electrically continuous (or whether or not electrical contacts at which positions are electrically continuous) may also be employed.

For the image forming apparatus 100 in this embodiment, when the above-described fixing device 9 is the general-purpose fixing device, separately from the fixing device 9, another fixing device (for the envelope) 9A is prepared as a fixing device exclusively for the envelope. A constitution of the fixing device 9A exclusively for the envelope is the same as the constitution of the above-described general-purpose fixing device 9 shown in FIG. 7. However, as shown in Table 1 below, a total pressure for causing the pressing roller 41 to be press-contacted to the fixing roller 40 is 588 N (about 60 kgf), and a reverse-crown amount of an outer diameter shape of the pressing roller 41 is 150 μm.

This is because in contrast to general cut paper (general-purpose paper), the envelope is in a bag shape such that the paper is superposed, and therefore creases are liable to generate and in order to eliminate the crease, there was a need to increase the reverse-crown amount. Further, at a portion where a degree of overlapping is large, for example, at a flap portion, pressure in the nip is high only thereat, and therefore a difference in glossiness of the toner image generates, so that there was a need that the pressure for the press-contact of the pressing roller 41 is reduced and the difference in glossiness is not readily generated.

TABLE 1

| Type*¹ | UF⁺² (N) | RAC*³ (μm) |
|---|---|---|
| FGPP*⁴ | 784 | 40 |
| FE*⁵ | 588 | 150 |

*¹“Type” is the type (species) of the fixing device.
*²“UF” is the urging force.
*³“RCA” is the reverse-crown amount of the pressing roller.
*³“FGPP” is for the general-purpose paper.
*⁵“FE” is for the envelope.

When the envelope is passed through the fixing device, the fixing device 9A for the envelope is used after the general-purpose fixing device 9 is exchanged (replaced) by the user therewith. The CPU 400 controls an operation (the pressure of the fixing device, a feeding speed of the sheet and the like) of the image forming apparatus on the basis of the fixing device discrimination information acquired from the discriminating portion 403 of the fixing device mounted in the image forming apparatus.

### (3) Selection of Print Preferential Order Mode

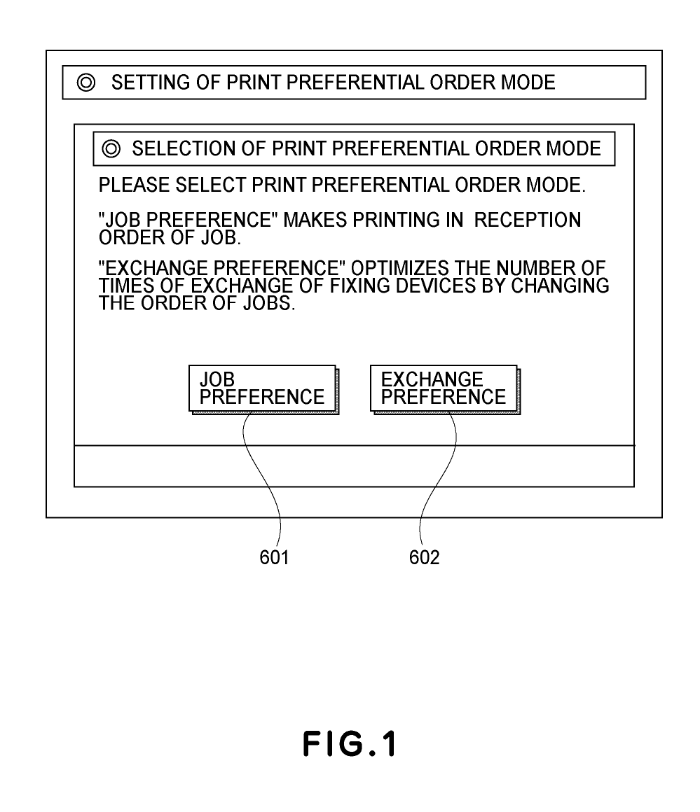

The user can display a “print preferential order mode” screen as shown in FIG. 1 by operating an operating portion S of the image forming apparatus 100. Using this screen, the user is capable of selecting a “job preferential mode” and an “exchange preferential mode” in advance. At this time, the CPU 400 (display controller) controls display contents of a liquid crystal screen 26 of the operating portion S, and thus causing the liquid crystal screen 26 to display the screen shown in FIG. 1.

The job preferential mode is the print preferential order mode in which printing is made in reception order of jobs. That is, even in the case where replacement of the fixing device is required to be made plural times in a process of executing a series of a plurality of image forming jobs for forming images on a plurality of different species of sheets, an operation is executed in the job reception order.

The exchange preferential mode is the print preferential order mode in which the number of times of exchange of the fixing device is optimized by replacing the order of jobs. That is, in the case where the replace of the fixing device is required to be made plural times in the process of executing the series of the plurality of image forming jobs for forming the images on the plurality of different species of sheets, the order of the series of the plurality of image forming jobs is changed in order to decrease the number of times of exchange of the fixing device.

When the user presses a job preferential button (key) 601 and thus selects the job preferential mode, the CPU 400 effects the image formation as in reservation order of the plurality of jobs which are successively reserved (received). On the other hand, when the user presses an exchange preferential button (key) 602 and thus selects the exchange preferential mode, the CPU 400 replaces the order of jobs so that the number of times of the exchange of the fixing device becomes small.

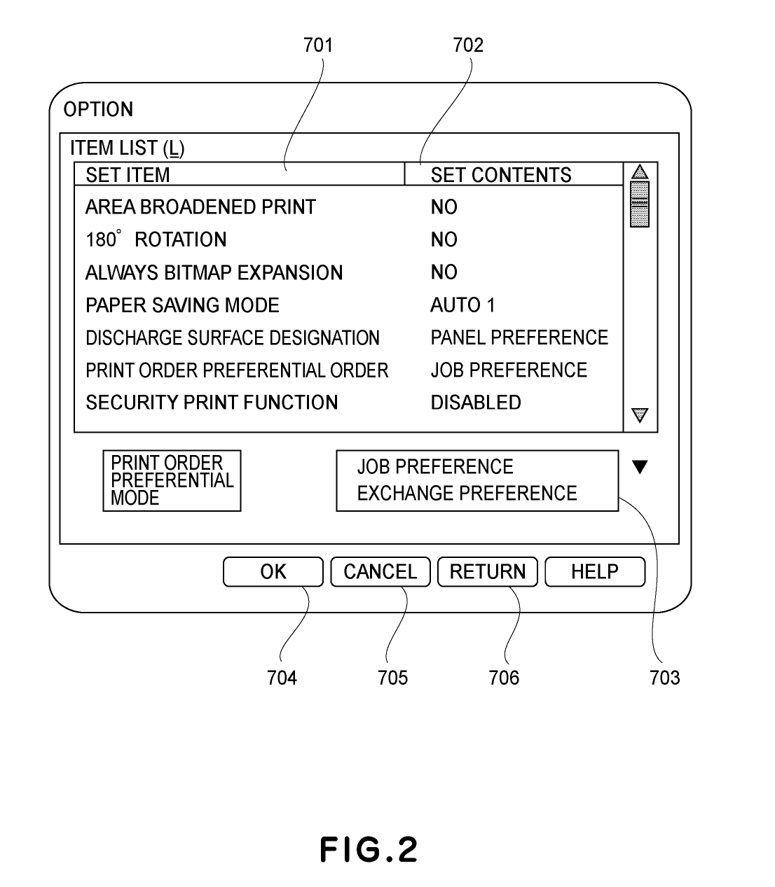

Incidentally, setting of the mode is capable of being made through a host computer (PC) 401 connected with the image forming apparatus via a LAN cable. FIG. 2 is a setting screen (printer driver) displayed on a monitor 401A connected with the PC 401. The CPU 400 controls a subsequent image forming operation depending on information on the mode selected in the setting screen shown in FIG. 2.

In the case where the user wishes to change the setting, when the user selects an associated item from set items 701, options (choices) for the associated item are displayed in a pull-down menu 703. In this case, a state in which the options consisting of the “job preferential mode” and the “exchange preferential mode” are displayed is shown.

When the user selects a desired one of the options, a selection results displayed on set contents 702. Thereafter, when the user presses an OK button 704, a set result is sent from the PC 401 to the CPU 400 of the image forming apparatus via the connection interface 402. Further, when the user does not press the OK button 704 but presses a cancel button 705, selected setting is not sent to the CPU 400 of the image forming apparatus, and the setting screen of FIG. 2 disappears.

A button 706 for returning the setting to a default setting is a button for returning the setting to an initial setting, and thus returns all of the items displayed in the set items 701 to initially set items. Thereafter, when the OK button 704 is pressed, the initial setting is sent to the CPU 400 of the image forming apparatus.

The functions described above can properly use the case where the image formation is intended to be effected as in the job reservation order and the case where an image formation time is intended to be shortened by exchanging the fixing device, depending on a status of use by the user.

### (4) Operation Control of Image Forming Apparatus

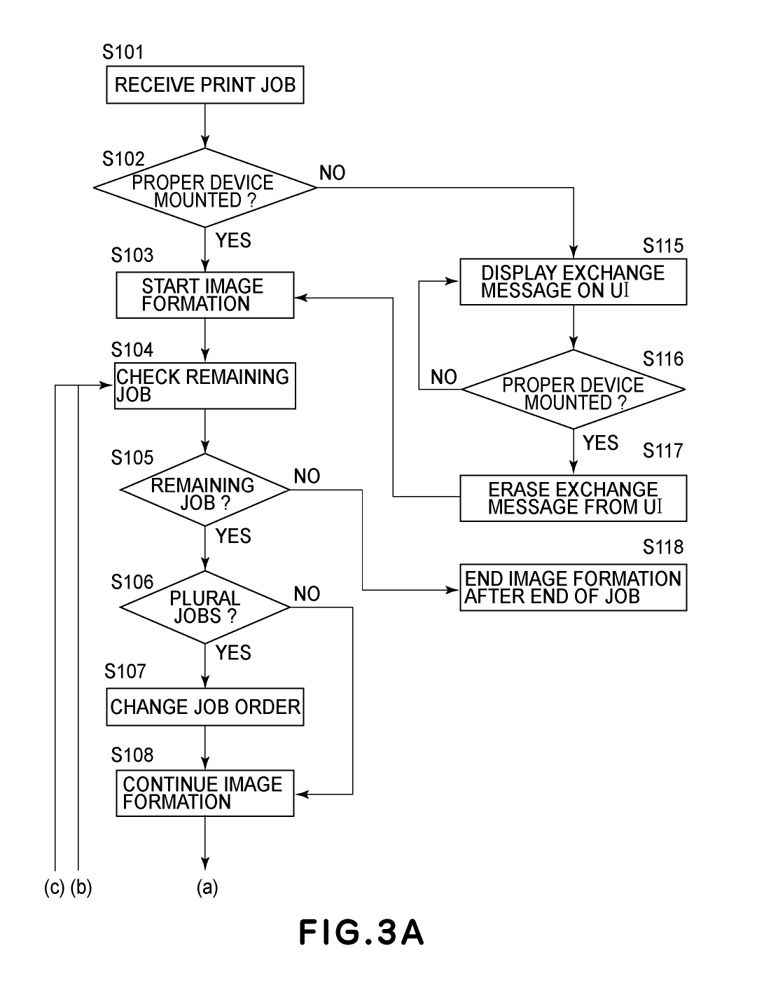

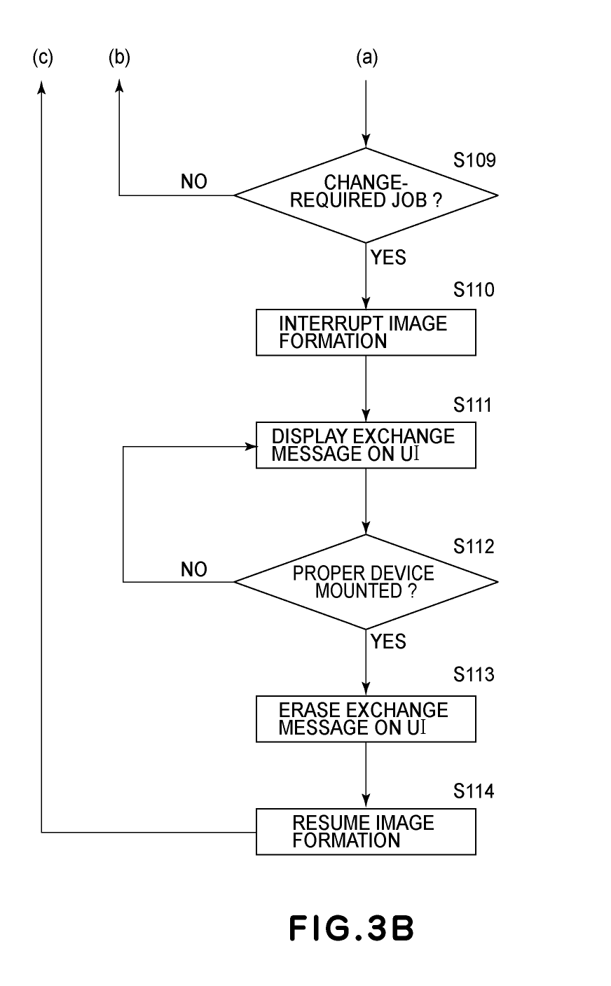

FIGS. 3A and 3B are a flowchart showing control and an operation of the image forming apparatus 100 from a start to an end of an image forming operation in the case where the exchange preferential mode is selected in advance. This control flow is executed by controlling various devices by the CPU 400 (executing portion).

A printing job (image forming job) to which image data and recording material information are added is sent to the CPU 400 from the operating portion S or from the PC 401 or the like connected to the CPU 400 via the connection interface 402 (S101).

Then, first, the CPU 400 makes determination as to whether or not the fixing device 9 currently mounted is suitable for sheets subjected to image formation corresponding to the job on the basis of the recording material (sheet) information added to the job (S102).

That is, the CPU 400 reads fixing device type information (discrimination information) stored in advance in the memory 403 as a discriminating portion mounted in the currently mounted fixing device 9. The CPU 400 checks the read discrimination information against the sheet information added to the job and determines whether or not the sheet information of the job and the fixing device direction to each other.

In the case where the sheet information of the job and the fixing device do not adapt to each other, a message (fixing device replacement message) for urging the user to exchange (replace) the fixing device 9 is displayed on the display portion 26 of the operating portion (UI) S or on a screen of the monitor 401A connected with the PC 400 (S115). Then, the image forming apparatus is in stand-by until the fixing device suitable for the job is mounted (S116).

The CPU 400 determines whether or not the replaced fixing device adapts to the job by checking the fixing device type discrimination information acquired from the memory 403 of the replaced fixing device against the sheet information added to the job. When the replaced fixing device adapts to the job, the message for urging the user to exchange the fixing device is erased (S117). When adaptation of the fixing device type discrimination information to the sheet information added to the job can be confirmed, the image forming operation is started (S103).

Simultaneously with the image formation, whether or not a job (remaining job) subsequent to the job in which the image forming operation is currently performed exist (i.e., the remaining job is received) (S104, S105). When there is no remaining job, the image forming operation is ended upon completion of the job currently operated (S118).

In the case where there are remaining jobs, on the basis of pieces of the sheet information added to the jobs, whether or not fixing device exchange made plural times generates is discriminated (S106). In the case where the remaining job does not require the exchange of the fixing device or is a single job, the image formation is continued as it is (S108).

In the case where the plural times of the fixing device exchange are required, the execution order of the image forming job is changed so that the job using the same fixing device as the fixing device used in the current job is given preference (S107).

In FIG. 4, (a) shows an example of job replacement in the case where a job for cut paper (plain paper) and a job for the envelope are alternately inputted. In the case where the job preferential mode shown on an upper side is selected, the image formation is effected in job reception order (reservation order). In this case, 3 times of a fixing device exchange operation generates. That is, the CPU 400 (determining portion) determines the number of times of the fixing device replacement required in a process in which the plurality of jobs successively reserved are executed. The example on the upper side of (a) of FIG. 4 is the case where the number of times of the fixing device replacement needs plural times.

On the other hand, in the case where the operation mode is designated to the exchange preferential mode shown on a lower side of (a) of FIG. 4, by the determination in S106, the execution order of the jobs is changed so that the cut paper job takes preference over the envelope job. Then, the image formation is continued until the job before the job remaining the fixing device exchange while the CPU 400 determines whether or not the job is the job requiring the fixing device exchange (S108, S109).

When the image forming operation order reaches timing of the job requiring change of the fixing device, the image forming operation is once interrupted (S110). Then, the CPU 400 causes the display portion 26 of the operating portion S or the display portion 401A of the PC 401 to display the message for urging the user to exchange (replace) the fixing device on the screen, and the image forming apparatus is in stand-by until the fixing device adapting to the job is mounted (S111, S112).

The CPU 400 determines whether or not the replaced fixing device adapts to the job by checking the fixing device type information acquired from the memory 403 of the replaced fixing device against the sheet information added to the job. When the replaced fixing device adapts to the job, the exchange urging message is erased (S113). In this way, when the adaptation of the fixing device to the sheet for the job can be confirmed, the image forming operation is resumed (S114).

The above operation is continued as long as the job remains, and when there is no subsequent job, the image forming operation is ended (S118).

Further, also in the case of an example shown in (b) of FIG. 4, similarly as in (a) of FIG. 4, the execution order of reserved 4 jobs is controlled by the CPU 400 depending on whether the case in the case where the job preferential mode is selected (the case where the number of times of replacement is 3 (times)) or the case where the exchange preferential mode is selected (the case where the number of times of replacement is 1 (time)).

Incidentally, not only in the examples shown in (a) and (b) of FIG. 4 but also in the case where the plurality of jobs successively reserved are intended to be executed in the reservation order, the present invention is effective in the case where the fixing device replacement is required to be performed over a plurality of times. That is, the number of jobs successively reserved is not limited to 4, but may also be 5 or more or may also be 3.

With respect to feeding of the sheets P from the sheet feeding cassettes 10A to 10D, the CU 400 drives a feeding mechanism for the select feeding cassette disposed at a stage where the sheets P corresponding to the sheet information added to the job to be executed are accommodated, so that the sheets P are separated and fed one by one and the image formation is executed. When absence of the sheet in the sheet feeding cassette is detected by a sensor (not shown) during execution of a continuous image forming operation, the CPU 400 once interrupts the image forming operation and causes the display portion 26 of the operating portion S or the monitor 401A connected with the PC 401 to display a message for urging the user to replenish the sheets on the screen. When the replenishment of the sheets is detected by the sensor, the image forming operation is resumed.

Further, the CPU 400 effects the following control in the case where no accommodation of the sheet P corresponding to the sheet information added to the job in the sheet feeding cassettes at all of the stages is detected by the sensor when the job is inputted or during execution of the job. That is, on the screen of the display portion 26 of the operating portion S or the monitor 401A connected with the PC 401, a message for urging the user to replace the sheets in the sheet feeding cassette(s) at any(one) of the stages with the sheets corresponding to the sheet information added to the job is displayed. When execution of the replacement of the sheets is detected by the sensor, the job is executed.

As described above, in the image forming apparatus in which the plurality of fixing devices are exchanged and used depending on the species of the sheets, as in this embodiment, the image formation order of the jobs is changed so that the number of times of exchange of the fixing device is reduced. That is, in the case where a series of a plurality of image forming jobs for forming images on a plurality of sheets in species is executed, the CPU 400 changes the execution order of the plurality of image forming jobs depending on the discrimination information acquired by the acquiring portion for the mounted fixing device.

As a result, a waiting time due to the fixing device exchange and the number of times of an exchanging operation were able to be reduced, so that it was possible to alleviate a load on the user. As a specific example, in the jobs inputted in the order as shown on the upper side of (a) of FIG. 4, when the image formation order is not changed, 3 times of the fixing device exchange are required until the image formation is ended. However, as shown on the lower side of (a) of FIG. 4, by changing the image formation order, the series of image forming operations is ended by the single fixing device exchange.

In the above, as an embodiment to which the present invention is applied, the above-mentioned embodiment was described, but within the scope of the idea of the present invention, various constitutions can be replaced with other constitutions.

For example, the image forming apparatus is not limited to the color image forming apparatus, but may also be a monochromatic (single color) image forming apparatus for forming a monochromatic image.

For example, the fixing device 9 (9A) is not limited to the device for heating and fixing the unfixed toner image formed on the recording material. The fixing device 9 (9A) also encompasses a device used for also a treatment for adjusting surface glossiness of an image by re-heating the toner image which is partly fixed or which has already been fixed (also in this case, the device is called the fixing device).

For example, the fixing device 9 (9A) may also employ a device constitution using a flexible endless belt as either one or both of the fixing member 40 and the pressing member 41. Further, the heating mechanisms for the fixing member 40 and the pressing member 41 are not limited to the halogen heater, but can also have a constitution appropriately employing another heating mechanism of a ceramic heater type, an electromagnetic induction heating type, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications Nos. 2015-095640 filed on May 8, 2015, and 2016-040917 filed on Mar. 3, 2016, which are hereby incorporated by reference herein in their entirety.

What is claimed is:

1. An image forming apparatus comprising:
an image forming portion configured to form a toner image on a recording material to execute a job;
a fixing portion configured to fix, on the recording material, the toner image formed by said image forming portion, said fixing portion being capable of being replaced with another fixing portion depending on a content of the job; and
a selecting portion configured to cause an operator to select one of a plurality of modes when a plurality of jobs are successively reserved, the plurality of modes including a first mode in which execution order is changed so as to decrease a number of times of replacement of said fixing portion and then the plurality of jobs are executed in the changed execution order and a second mode in which the plurality of jobs are executed in reserved order.

2. An image forming apparatus according to claim 1, further comprising a controller configured to control the execution order of the plurality of jobs depending on the mode selected by said selecting portion.

3. An image forming apparatus according to claim 2, wherein when the first mode is selected, said controller replaces the execution order of the plurality of jobs so that the job using said fixing device mounted in said image forming apparatus is given preference.

4. An image forming apparatus according to claim 1, wherein said selecting portion includes a display portion and a display controller configured to control a display content at said display portion.

5. An image forming apparatus according to claim 4, wherein said display controller displays a key for selecting the first mode and a key for selecting the second mode at said display portion.

6. An image forming apparatus according to claim 4, wherein said display controller displays a message urging the operator to replace said fixing portion at the display portion when discrimination that replacement of said fixing portion is needed is made.

7. An image forming apparatus according to claim 1, further comprising a mounting portion configured to selectively mount one of a plurality of fixing portions of species including a first fixing portion capable of fixing the toner image on the recording material of a predetermined species including a predetermined envelope and a second fixing portion capable of fixing the toner image on the recording material of a predetermined species not including the predetermined envelope.

8. An image forming apparatus comprising:
an image forming portion configured to form a toner image on a recording material to execute a job;
a fixing portion configured to fix, on the recording material, the toner image formed by said image forming portion;
a mounting portion configured to selectively mount one of a plurality of fixing portions of species including a first fixing portion capable of fixing the toner image on the recording material of a predetermined species including a predetermined envelope and a second fixing portion capable of fixing the toner image on the recording material of a predetermined species not including the predetermined envelope; and
a selecting portion configured to cause an operator to select one of a plurality of modes when a first job using a first fixing portion, a second job using a second fixing portion and a third job using a first fixing portion are successively reserved, the plurality of modes including a first mode in which the first job, the third job and the second job are executed in listed order and a second mode in which the first job, the second job and the third job are executed in listed order.

9. An image forming apparatus according to claim 8, further comprising a controller configured to control the execution order of the plurality of jobs depending on the mode selected by said selecting portion.

10. An image forming apparatus according to claim 8, wherein said selecting portion includes a display portion and a display controller configured to control a display content at said display portion.

11. An image forming apparatus according to claim 10, wherein said display controller displays a key for selecting the first mode and a key for selecting the second mode at said display portion.

12. An image forming apparatus according to claim 10, wherein when the first mode is selected, said display controller displays a message urging the operator to replace said third fixing portion with said second fixing portion at the display portion with completion of execution of the third job.

13. An image forming apparatus according to claim 10, wherein when the second mode is selected, said display controller displays a message urging the operator to replace and first fixing portion with said second fixing portion with completion of execution of the first job and displays a message urging the operator to replace said second fixing portion with said first fixing portion with completion of execution of the second job.

14. An image forming apparatus comprising:
an image forming portion configured to form a toner image on a recording material to execute a job;
a fixing portion configured to fix, on the recording material, the toner image formed by said image forming portion;
a mounting portion configured to selectively mount one of a plurality of fixing portions of species including a first fixing portion capable of fixing the toner image on the recording material of a predetermined species including a first recording material and a second fixing portion capable of fixing the toner image on the recording material of a predetermined species not including the first recording material;
a determining portion configured to detect a number of times of replacement of said fixing portions in a process in which a plurality of jobs are executed; and
a selecting portion configured to cause an operator to select one of a plurality of modes when the plurality of jobs in which a plurality of numbers of times of replacement of said fixing portions is needed on the basis of a determination result of said determining portion are successively reserved, the plurality of modes including a first mode in which execution order is changed so as to decrease the number of times of replacement of said fixing portions and then the plurality of jobs are executed in the changed execution order is changed and a second mode in which the plurality of jobs are executed in reserved order.

15. An image forming apparatus according to claim 14, further comprising a controller configured to control the execution order of the plurality of jobs depending on the mode selected by said selecting portion.

16. An image forming apparatus according to claim 15, wherein when the first mode is selected, said controller replaces the execution order of the plurality of jobs so that the job using said fixing device mounted in said mounting portion is given preference.

17. An image forming apparatus according to claim 15, wherein said fixing portion includes a discriminating portion configured to discriminate a species thereof, and said controller controls the execution order of the plurality of jobs in the first mode depending on the species of said fixing portion indicated by said discriminating portion.

18. An image forming apparatus according to claim 17, wherein said discriminating portion includes a storing medium configured to store information corresponding to the species of said fixing portion, and said controller controls the execution order of the plurality of jobs in the first mode depending on the information stored in said storing medium.

19. An image forming apparatus comprising:
an image forming portion configured to form a toner image on a recording material to execute a job;
a fixing portion configured to fix, on the recording material, the toner image formed by said image forming portion, said fixing portion being capable of being replaced with another fixing portion depending on a content of the job; and
an executing portion configured to execute one of a plurality of modes when a plurality of jobs are successively reserved, the plurality of modes including a first mode in which execution order is changed so as to decrease a number of times of replacement of said fixing portion and then the plurality of jobs are executed in the changed execution order and a second mode in which the plurality of jobs are executed in reserved order.
